(19) United States
(12) Patent Application Publication
(10) Pub. No.: US 2009/0160814 A1
(43) Pub. Date: Jun. 25, 2009

(54) HOT FUNCTION SETTING METHOD AND SYSTEM

(75) Inventors: Yuan LI, Nanjing (CN); Qiang Fan, Nanjing (CN)

Correspondence Address: Muncy, Geissler, Olds & Lowe, PLLC, P.O. BOX 1364, FAIRFAX, VA, 22038-1364, US

(73) Assignee: Inventec Appliances Corp.

(21) Appl. No.: 12/340,176

(22) Filed: Dec. 19, 2008

(30) Foreign Application Priority Data
Dec. 21, 2007 (TW) 096149539

(51) Int. Cl. G06F 3/041

(52) U.S. Cl. 345/173

(57) ABSTRACT

A method for setting a hot function for a user on an electronic device having a touch screen, hot function modules for providing hot functions, and a database storing recognizable traits, the recognizable traits being corresponding to the hot function modules. The function setting method includes the steps of: (i) recognizing traits input by the user through the touch screen; (ii) matching the input traits with at least one of the recognizable traits in the database; and (iii) activating at least one of the hot function modules to set at least one hot function, wherein the least one of the hot function modules corresponds to the least one of the recognizable traits.

This application claims the benefit of the Taiwan Patent Application Serial NO. 096149539, filed on Dec. 21, 2007, the subject matter of which is incorporated herein by reference.

### BACKGROUND OF THE INVENTION

1. Field of the Invention

The present invention relates to a hot function setting method and system, more particularly to a hot function setting method to be implemented in electronic device having a touch screen.

2. Description of the Prior Art

Due to the economic development and progress in the communication field, a portable electronic device, such as a mobile phone or a PDA (Personal Digital Assistant), becomes an indispensable consumer article in our daily life so that each person has at least one mobile phone in possession. Since it is convenient to be carried along with the user, the communicate system between the parties concerned is shifted from the lined phone in a room to a cable-free outdoor environment.

The design of the electronic device has been developed to conform with the modern technology (i.e. compact design) in order to facilitate the user for carrying along with him. The display screen of the electronic device should be large enough to provide sufficient visual effect to the user. The object therefore leads invention of the touch screen, in which, all the spaces occupied by the function keys or buttons are converted into the screen space. Hence, a large display screen becomes available. In order words, a stylus is used for pressing or tapping the virtual buttons in the home screen substituting the original buttons or keys.

However, the touch screen (generally called home screen) of a mobile phone or a PDA displays a function selection menu to permit the user for choosing an item in the menu to enter into a desired function. The function selection menu is set in advance by the build-in system of the electronic device so that the user cannot alter the content of the function selection menu according to the requirement or habit of an individual user. This causes discomfort and inconvenience to the user during operating on the electronic device.

Therefore, the manufacturers of late have arranged a plurality of quick “function keys” on the touch screen of the electronic device so that when a user touches the screen, the interface will display a function election list consisting of frequently used functions to permit the user to choose therefrom. Alternately, the interface of the touch screen is arranged with a plurality of “hot press keys”, which are in the form of icons. To enter into a desired function selection menu, the use can quickly click or double click a respective icon to open the function selection menu.

However, the aforementioned recognition is restricted due to numbers of the icons, dimension of the touch screen, the size of the icons and arrangement of the icons in an aesthetic effect.

Some manufacturers have fabricated the input interface of the electronic device to possess multi-touch capability. The multi-touch technology implies multi-touch interfaces, such as keyboard and mouse, for inputting data and they appear on the interface as virtual keyboard and virtual mouse. For instant, an iPhone is provided with a built-in recognition system having different programs for executing different functions, such as you can touch two fingers on a single image and the image is maximized when you spread the fingers outward away from each other. The image is minimized when you squeeze your fingers towards each other. In practice, it is relatively difficult to move several fingers on a 3.5″ wide touch screen of the electronic device to accomplish a recognition. With the given space, the system is unable to provide precise recognition of the function. In addition, the command for spreading out or narrowing the image is set in advance by the recognition system of the electronic device and the user can follow those same commands only. In short, the user is unable to set up his individual commands based on his requirement and habit to execute the corresponding different programs.

Therefore, the object of the present invention is to a new plan to solve the above-mentioned problems.

### SUMMARY OF THE INVENTION

The object of the present invention is to provide a function setting method for setting user hot functions and system thereof and is implemented within an electronic device so that the user can quickly locate and find out the desired hot function being displayed in the touch screen of the electronic device.

The electronic device of the present invention features a method of setting a hot function for a user on the electronic device. The electronic device accordingly includes: a touch screen for inputting traits by the user; hot function modules for providing hot functions; a database storing recognizable traits, the recognizable traits being corresponding to the hot function modules; and a control unit for recognizing the input traits, matching the input traits with at least one of the recognizable traits in the database, and activating at least one of the hot function modules to set at least one hot function, wherein the at least one of the hot function modules corresponds to the at least one of the recognizable traits.

A method for setting a hot function for a user on an electronic device is provided according to the present invention. The electronic device has a touch screen, hot function modules for providing hot functions, and a database storing recognizable traits corresponding to the hot function modules. The function setting method includes the steps of: (i) recognizing traits input by the user through the touch screen; (ii) matching the input traits with at least one of the recognizable traits in the database; and (iii) activating at least one of the hot function modules to set at least one hot function, wherein the at least one of the hot function modules corresponds to the at least one of the recognizable traits.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a block diagram illustrating the steps in a hot function setting method according to the present invention for an individual;

FIG. 2A shows the first embodiment of the hot function setting method of the present invention;

FIG. 2B shows the second embodiment of the hot function setting method of the present invention;

FIG. 2C shows the third embodiment of the hot function setting method of the present invention;

FIG. 2D shows the fourth third embodiment of the hot function setting method of the present invention; and

FIG. 2E shows the fifth embodiment of the hot function setting method of the present invention.

### DETAILED DESCRIPTION OF THE PREFERRED EMBODIMENTS

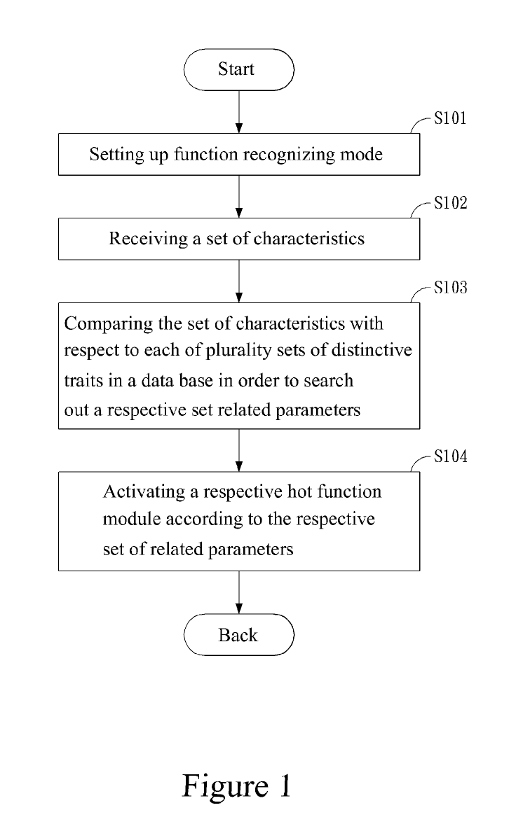

FIG. 1 is a block diagram illustrating the steps in a method according to the present invention for setting a hot function for a user on an electronic device. The hot function setting method and system according to the present invention is implemented within the electronic device (not shown) having a touch screen, hot function modules for providing hot functions (quick keys) and a database storing a plurality of recognizable traits corresponding to the hot function modules respectively. The electronic device described in the present specification can be, but not limited to, a mobile phone or a PDA. The touch screen uses for example resistive or capacitive materials to detect the touch and location of the touch. The touch screen can also use infrared ray or CCD (Charge Couple Device) to detect location of the touch.

When the user wishes to set up hot functions (quick keys) for his use, he can execute the present method by firstly entering into a recognition mode (S101). The recognition mode may be for example a figure recognition mode, a numeral recognition mode, a letter/character recognition mode and a symbol recognition mode. Each of the preceding modes includes plurality of recognizable traits. Therefore, when the user inputs a set of traits onto the touch screen by touching (S102), the touch screen detects and recognizes the input traits and matches the input traits with at least one of the recognizable traits in the database of the electronic device. After matching, the user can activate the hot function modules to set at least one hot function, wherein the hot function modules respectively correspond to the sets of recognizable traits (S103). Since correspondences between the hot function modules and the recognizable traits are set and stored within the system of the electronic device and therefore when the user inputs some of the recognizable traits in future, the system will immediately command the corresponding hot function modules to set at least a hot function (S104).

The electronic device of the present invention includes a touch screen capable of displaying a function selection menu from which the user can choose a recognition mode, and a plurality of hot function modules. The electronic device further has a memory device for storing a database used to store a plurality of recognizable traits; a plurality of hot function modules respectively corresponding to the recognizable traits; correspondences between the recognizable traits and the hot function modules; and a control unit for recognizing the input traits, matching the input traits with at least one of the recognizable traits in the database, and activating at least one of the hot function modules to set at least one hot function, wherein said at least one of the hot function modules corresponds to said at least one of the recognizable traits. The recognizing of the input traits, for example in the form of a touch track left by the user on the touch screen, may be determined upon detecting two coordinates of the touch track. When the recognition mode is chosen, the user can activate the device to detect and recognize the input traits and search for the corresponding hot function modules. When the electronic device is used under a normal condition, in case the user inputs the similar touch track representing the input traits, the same will be recognized by the control unit. The control unit then uses the input traits to search for at least one of the recognizable traits which are matched with the input traits, and then activates at least one of the hot function module according to the at least one of the recognizable traits. In other words, the user can input several different input traits to activate the corresponding hot functions. In the event the touch screen is unable to recognize the touch track correctly, the touch screen display a hot function menu including some of hot function modules corresponding to some of the recognizable traits. The user can select a hot function module from the hot function menu.

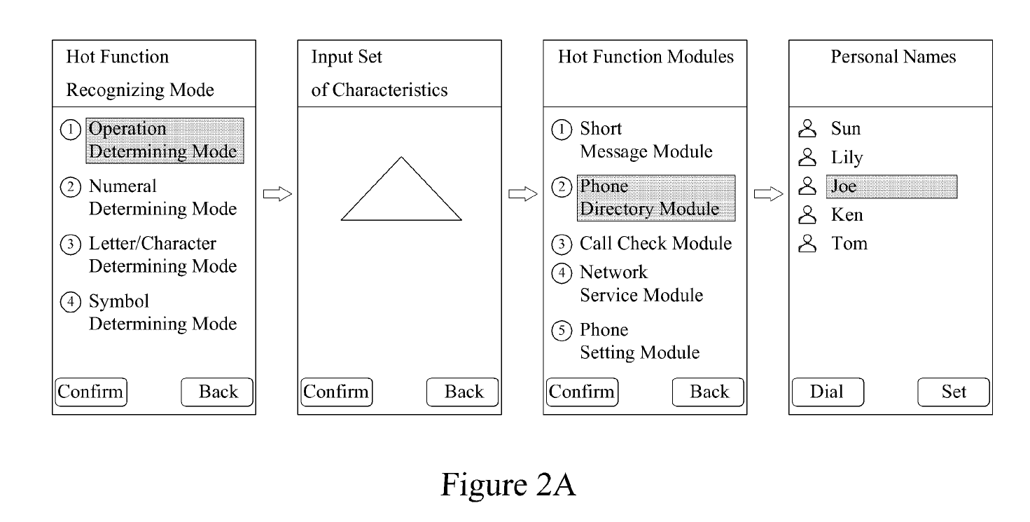

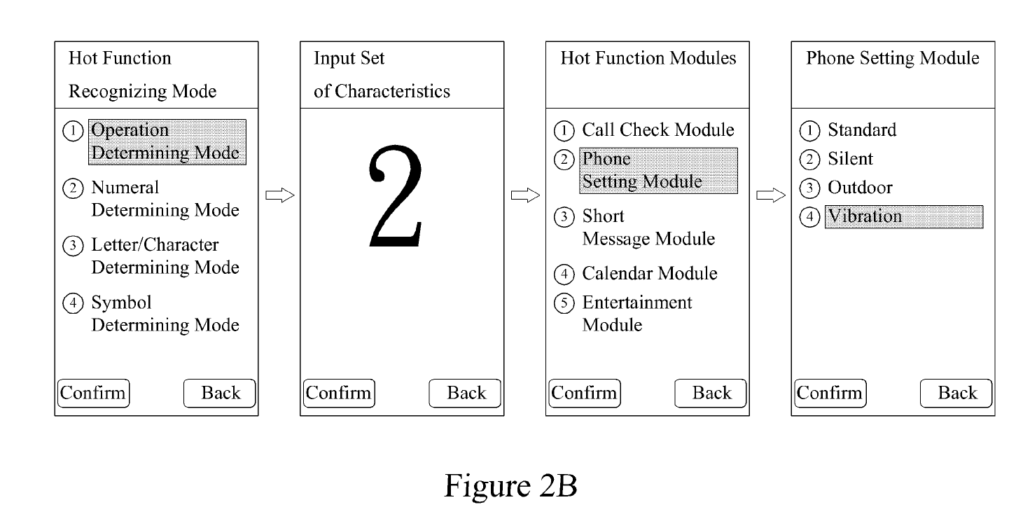

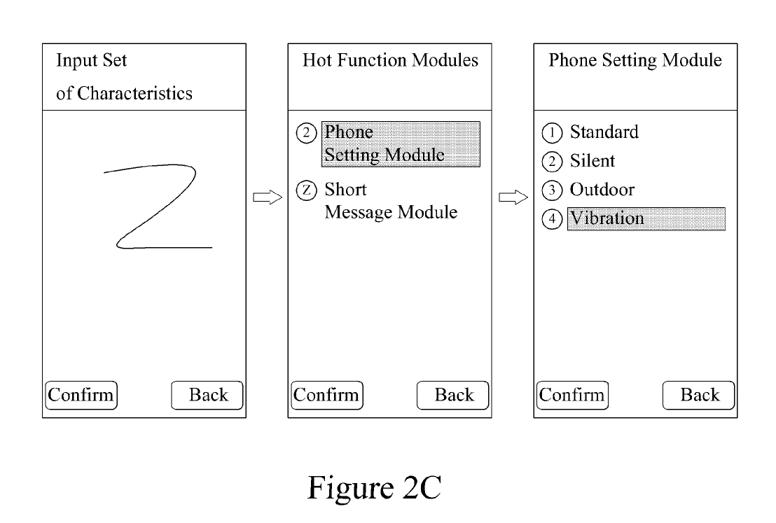

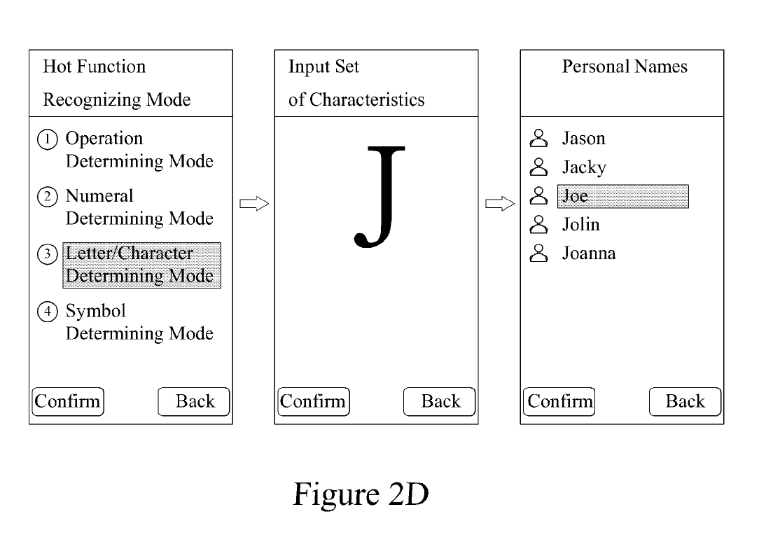

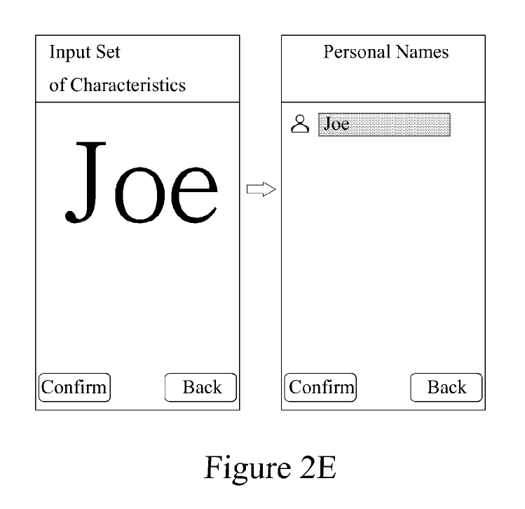

FIG. 2A shows the first embodiment of the hot function setting method of the present invention, wherein the function recognition mode includes a figure recognition mode, a numeral recognition mode, a letter/character recognition mode and a symbol recognition mode. As illustrated in the steps, when the user selects one of the figure recognition mode, the numeral recognition mode, the letter/character recognition mode and the symbol recognition mode to execute, each recognition mode consists of several recognizable traits. The input traits are selected from a group containing an upward stroke, a downward stroke, a leftwise stroke, a rightwise stroke, one circle, one triangle, a hexagon, a wavelike figure and a combination of the preceding elements. The recognizable traits of the figure recognition mode may include any figures configured according to the desired of the user, even the Chinese character [symbol] “”, “⋆”, etc. The recognizable traits of the numeral recognition mode may include Arabic Numerals. The recognizable traits of the letter/character recognition mode may include letter/character in big or small capital. The recognizable traits of the symbol recognition mode may include English punctuation marks, mandarin strokes and several specific signs. And the restrictions as mentioned should not be limited thereto. Each time, when the user inputs a set of traits, a respective hot function module will be activated since the input traits being corresponding to a set of recognizable traits, which, in turn, is corresponding to a specific hot function module. The hot function modules include a short message module, a phone directory module, a call check module, a network service module, a phone setting module, a calendar module and an entertainment module. And the restrictions as mentioned should not be limited thereto. In the present embodiment, in case the user inputs a [symbol] , the phone directory module is selected optionally, because [symbol] corresponds to the phone directory module in the hot function module list. Briefly speaking, the user can set up the set of recognizable traits in advance and later if he scribbles the [symbol] on the touch screen, he gets to the phone directory module. Of course, the phone directory module will display the list of personal names and their phone numbers respectively.

FIG. 2B shows the second embodiment of the hot function setting method of the present invention, wherein the recognition of the touch screen is the same as the previous embodiment. If the user selects the numeral recognition mode and after he has inputted “2” on the touch screen, he can immediately get to the phone setting module. There, he can further select the required reminding mode, such as the phone vibrates upon receipt of a call. For the purpose of avoiding the confusion of the input traits, the function mode is selected in advance. For example, in case of inputting [2] or [Z], the recognizing system of the electronic device will not be able to recognize and determine which one is correct.

FIG. 2C shows the third embodiment of the hot function setting method of the present invention, wherein in case the user, prior to selecting a set of recognizable traits, scribbles “Z” generally similar to printed word “2” on the touch screen, the recognizing system will not be able to recognize and thus determine which one of “2” and “Z” is correct. Under this situation, the touch screen will display a hot function module containing two items, namely “2” and “Z”, to permit the user to choose the desired item by clicking, in which, “2” represents the phone setting mode while “Z” represents the short message module, so as to avoid the problem of executing the wrong module.

Regarding to which hot function module should be correspond to an input traits, the user can set up the hot function according to his requirement. The setting stages of the input traits should not be limited thereto. FIG. 2D shows the fourth third embodiment of the hot function setting method of the present invention for an individual user. When the user selects the letter/character recognition mode, he can input a set of traits, such as “J”, the touch screen of the electronic device will, upon detecting the touch track directly, execute the corresponding function module after searching out the related recognizable traits from the database. Thus, the names in the phone directory module beginning with “J” will appear on the touch screen. Under this condition, the user can talk to a desired person by clicking a desired name, such as “Joe”. Since the user is not required to enter the function recognition mode in the third and fourth embodiments, he can directly enter into the required recognition mode so that the time for accessing to the desired phone number is minimized in comparison to the first and second embodiments.

FIG. 2E shows the fifth embodiment of the hot function setting method of the present invention. After the hot function setting method is implemented in a mobile phone and in case, the user inputs a specific set of traits, such as “Joe”, the phone number of “Joe” will be immediately displayed over the touch screen. Comparing the fifth embodiment with respect to the third and fourth embodiments, the user gets the phone number of the desired person without entering into the recognition mode, thereby skipping the list of recognition mode for accessing the desired phone number more quickly. The above-mentioned embodiments are illustrated only as examples and should not be limited thereto.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for setting a hot function for a user on an electronic device having a touch screen, hot function modules for providing hot functions, and a database storing recognizable traits, the recognizable traits being corresponding to the hot function modules, the function setting method comprising the steps of:
(i) recognizing traits input by the user through the touch screen;
(ii) matching the input traits with at least one of the recognizable traits in the database; and
(iii) activating at least one of the hot function modules to set at least one hot function, wherein said at least one of the hot function modules corresponds to said at least one of the recognizable traits.

2. The function setting method according to claim 1, further comprising, prior to the step (i), a step of selecting a recognition mode for recognizing the input traits.

3. The function setting method according to claim 2, wherein said recognition mode comprises a figure recognition mode, a numeral recognition mode, a letter/character recognition mode or a symbol recognition mode.

4. The function setting method according to claim 1, wherein the input traits are selected from the group consisting of an upward stroke, a downward stroke, a leftwise stroke, a rightwise stroke, one circle, one triangle, a hexagon, and a wavelike figure.

5. The function setting method according to claim 1, wherein the hot function modules comprise a short message module, a phone directory module, a call check module, a network service module, a phone setting module, a calendar module, or an entertainment module.

6. The function setting method according to claim 1, wherein one of the input traits is in the form of a touch track left by the user on the touch screen.

7. The function setting method according to claim 6, wherein in the event said input trait of the touch track is unable to be correctly recognized, the touch screen displaying a hot function menu containing some of the hot functions corresponding to some of the recognizable traits, one of which is matched with said input trait of the touch track.

8. The function setting method according to claim 1, wherein correspondences between the recognizable traits and the hot function modules are set and stored in the electronic device

9. An electronic device featuring a method of setting a hot function for a user on the electronic device, comprising:
a touch screen for inputting traits by the user;
hot function modules for providing hot functions;
a database storing recognizable traits, the recognizable traits being corresponding to the hot function modules; and
a control unit for recognizing the input traits, matching the input traits with at least one of the recognizable traits in the database, and activating at least one of the hot function modules to set at least one hot function, wherein said at least one of the hot function modules corresponds to said at least one of the recognizable traits.

10. The electronic device according to claim 9, further comprising a figure recognition mode, a numeral recognition mode, a letter/character recognition mode or a symbol recognition mode.

11. The electronic device according to claim 9, wherein the input traits are selected from the group consisting of an upward stroke, a downward stroke, a leftwise stroke, a rightwise stroke, one circle, one triangle, a hexagon, and a wavelike figure.

12. The electronic device according to claim 9, wherein the hot function modules comprise a short message module, a phone directory module, a call check module, a network service module, a phone setting module, a calendar module, or an entertainment module.

13. The electronic device according to claim 9, wherein one of the input traits is in the form of a touch track left by the user on the touch screen.

14. The electronic device according to claim 13, wherein in the event said input trait of the touch track is unable to be correctly recognized, the touch screen displaying a hot function menu containing some of the hot functions corresponding to some of the recognizable traits one of which is e matched with said input trait of the touch track.

15. The electronic device according to claim 9, wherein correspondences between the recognizable traits and the hot function modules are set and stored in the electronic device.
